(19) United States
(12) Patent Application Publication
(10) Pub. No.: US 2026/0115097 A1
(43) Pub. Date: Apr. 30, 2026

(54) INTERCHANGEABLE JET MODULES FOR A SPA AND/OR BATHING SYSTEM

(71) Applicant: BULLFROG INTERNATIONAL, LC, Herriman, UT (US)

(72) Inventors: Richard Eddington, South Jordan, UT (US); Michael Andersen, American Fork, UT (US); Cory Shorr, Pine Canyon, UT (US); Chris Kamerath, Herriman, UT (US); Mark McLane, Lehi, UT (US); Mike Adams, West Jordan, UT (US)

(21) Appl. No.: 19/373,645

(22) Filed: Oct. 29, 2025

Related U.S. Application Data
(60) Provisional application No. 63/713,581, filed on Oct. 29, 2024.

(51) Int. Cl. A61H 33/02; A61H 33/00

(52) U.S. Cl. CPC A61H 33/027; A61H 33/6063; A61H 2033/0033; A61H 2201/0107

(57) ABSTRACT

This disclosure relates generally to interchangeable jet modules having improved air and water flow. An interchangeable jet module may include at least one jet, a manifold with a mounting surface for mounting a base portion of the at least one jet, and a jet plate with a mounting surface for mounting a top portion of the at least one jet. The module may also include a first array of air and water chambers underlying the manifold mounting surface, a second array of air and water chambers underlying the manifold mounting surface and in fluid communication with the first array of air and water chambers through a valve, and a third array of air and water chambers underlying the manifold mounting surface and in fluid communication with the first array of air and water chambers and the second array of air and water chambers through a second valve.

### CROSS REFERENCE TO RELATED APPLICATION

A claim for priority to the Oct. 29, 2024 filing date of U.S. Patent Application No. 63/713,581, titled INTERCHANGEABLE JET MODULES FOR A SPA AND/OR BATHING SYSTEM (“the '581 Provisional Application”) is hereby made pursuant to 35 U.S.C. § 119(e). The entire disclosure of the '581 Provisional Application is hereby incorporated herein.

### TECHNICAL FIELD

The present disclosure generally to interchangeable jet modules for use with a spa or bathing system, the interchangeable jet modules having improved air and water flow.

### BACKGROUND

An advance in the construction of spas has been the development of modular construction systems that allow for easier upgrading and repair of water jet systems in a spa. These modular systems are disclosed in U.S. Pat. No. 5,754,989, issued 26 May 1998, titled “PLUMBING AND SHELL SYSTEM FOR SPA”; U.S. Pat. No. 6,092,246, issued 25 Jul. 2000, titled “PLUMBING AND SHELL SYSTEM FOR SPA”; U.S. Pat. No. 6,000,073, issued 14 Dec. 1999, titled “JET ZONE DISTRIBUTION SYSTEM FOR SPAS”; U.S. Pat. No. 5,987,663, issued 23 Nov. 1999, “MODULAR SYSTEM FOR SPAS AND BATHING SYSTEMS”; U.S. Pat. No. 6,256,805, issued 1 Jul. 2001, titled “MODULAR SYSTEM FOR SPAS AND BATHING SYSTEMS”; U.S. Pat. No. 6,543,067, issued 8 Apr. 2003, titled “INTEGRATED MANIFOLD SYSTEM FOR SPAS”; U.S. Pat. No. 7,908,684, issued 22 Mar. 2007, titled SPAS AND BATHING SYSTEMS WITH UPGRADEABLE AND INTERCHANGEABLE JET STATIONS″ (Ludlow system); and U.S. Pat. No. 9,662,268, issued May 30, 2017, titled “SPAS AND BATHING SYSTEMS WITH ADVANCED INTERCHANGEABLE JET MODULES.” These patents provide background, and are hereby incorporated by reference in their entireties.

In modular systems, a shell, or spa containment, is constructed with depressions or hollows in a shell wall. Each of the hollows is fitted with a module that comprises a plate for the hollow upon which are mounted jets for injecting water into the spa shell. One or more water inlets extends through the shell to provide water for the jets. The water inlets may communicate water from a water supply. Also, air is supplied to the module from an air inlet and air supply. The flow of air and water through the jets, in isolation or combination, may be controlled to provide the user with a desired flow rate and corresponding sensation.

With this construction, using one or more standard hollow designs, the bathing system can be upgraded or repaired with new jets by an easy hand replacement of the module with a new one having the same or different jets.

While current modular spa systems have many advantages, there may be some difficulties. For example, the supply lines or tubing located behind the plate and that deliver water and air to the jets are susceptible to residual buildup on the supply lines or tubing from stagnant water and chemicals, the supply lines or tubing therefore requiring cleaning and eventual replacement. Furthermore, the tubing may be interwoven, therefore requiring time to separate the tubing. Such a configuration makes tubing cleanup, repair, and replacement more difficult.

A construction that provides the advantages of a modular spa but with enhanced water and air delivery would be an advance in the art.

### SUMMARY

Disclosed are interchangeable jet modules for use with a spa or bathing system, the interchangeable jet modules having improved air and water flow. A jet panel functions as a cover over the module with jets mounted in the panel. Water and air supply lines and related structure are also supported upon the backside of the module. The water supply lines are connected to the water supply system by a releasable manifold connection. This allows the jet panel and attached jets and supply lines to be easily removed and replaced by a user. A top panel supports the top edge of the jet panel and serves as a top cover to the module, so that the jet panel and the top panel enclose the module volume. The top panel includes structure for attaching the top panel to the spa shell to support the top panel and, in turn the top of the jet panel. The top panel may also be shaped to form a headrest surface, or include structure for attaching a headrest.

Disclosed are systems, devices, and/or methods of use thereof regarding interchangeable jet modules for use with a spa, the interchangeable jet modules having enhanced water and air delivery. In various aspects, an interchangeable jet module includes at least one jet, a manifold with a mounting surface for mounting a base portion of the at least one jet, a jet plate with a mounting surface for mounting a top portion of the at least one jet, and an array of air and water chambers underlying the manifold mounting surface. The air chambers are configured to receive air from an air supply and communicate the air to the at least one jet, the water chambers are configured to receive water from a water supply and communicate the water to the at least one jet, and the at least one jet communicates air and water to an external environment. The array of air and water chambers are arrayed side-by-side to each other in a cross-sectional plane generally parallel to and underlying the manifold mounting surface, with the array configured to allow multiple mounting locations on the manifold mounting surface wherever the underlying side-by-side water and air chambers are capable of being accessed by spaced air and water intakes on the at least one jet. Each air and water chamber of the array is set at an angle relative to the manifold mounting surface, the angle configured to (i) reduce turbulence of water flowing through the water chambers, (ii) reduce drag of air flowing through the air chambers, and (iii) increase drainage of water from the manifold.

In various aspects, an interchangeable jet module includes at least one jet, a manifold with a mounting surface for mounting a base portion of the at least one jet, and a jet plate with a mounting surface for mounting a top portion of the at least one jet. The module may also include a first array of air and water chambers underlying the manifold mounting surface, a second array of air and water chambers underlying the manifold mounting surface and in fluid communication with the first array of air and water chambers through a valve, and a third array of air and water chambers underlying the manifold mounting surface and in fluid communication with the first array of air and water chambers and the second array of air and water chambers through a second valve.

The air chambers of each of the first, second, and third arrays are configured to receive air from an air supply and communicate the air to the at least one jet, the water chambers of each of the first, second, and third arrays are configured to receive water from a water supply and communicate the water to the at least one jet, and the at least one jet communicates air and water to an external environment. The first, second, and third arrays of air and water chambers are arrayed vertically in a cross-sectional plane generally parallel to and underlying the manifold mounting surface. Actuation of the valve cuts off fluid communication between the first array of air and water chambers and the second array of air and water chambers.

In various aspects, a method of manufacturing an interchangeable jet module includes forming a hollow structure from a thermoplastic material, the hollow structure having a front and a back, and molding jet structures into an exterior surface of the front of the hollow structure. The method may also include internally forming dividing walls between the front and the back of the hollow structure and tacking off the dividing walls to form at least two chambers within the hollow structure, the at least two chambers including an air chamber and a water chamber. The molded jet structures may be in fluid communication with the at least two chamber, such that a mixture of air and water flows through the molded jet structures. Additionally, the molded jet structures may be for delivering the mixture of air and water into a containment, such as a spa.

Other aspects of the disclosed subject matter, as well as features and advantages of various aspects of the disclosed subject matter, should be apparent to those of ordinary skill in the art through consideration of the ensuing description, the accompanying drawings, and the appended claims.

### BRIEF DESCRIPTION OF THE DRAWINGS

In the drawings:

FIG. 1 illustrates a back, perspective view of an interchangeable jet module having a manifold and a jet plate;

FIG. 2 illustrates an exploded side view of the manifold from FIG. 1;

FIG. 3 illustrates a perspective view of a front or top portion of the manifold;

FIG. 4 illustrates a perspective view of a back or bottom portion of the manifold;

FIGS. 5 through 8 illustrate additional embodiments of the front or top portion of the manifold;

FIG. 9 illustrates a side view of another embodiment of an interchangeable jet module having a manifold and a jet plate;

FIG. 10 illustrates a side view of another embodiment of an interchangeable jet module having a manifold, a jet plate, and a grommet or seal therebetween;

FIG. 11 illustrates a jet plate of any one of the interchangeable jet modules of FIG. 1, 9, or 10;

FIG. 12 is a flowchart of one example method of manufacturing any one of the interchangeable jet modules of FIG. 1, 9, 10, or 11;

FIG. 13 illustrates one embodiment of an interchangeable jet module manufactured according to the method of FIG. 12;

FIG. 14 illustrates a cross-sectional view of the chambers formed in the manifold from the interchangeable jet module of FIG. 13; and

FIG. 15 illustrates a side cross-sectional view of an interchangeable jet module formed from the process described in FIG. 12.

### DETAILED DESCRIPTION

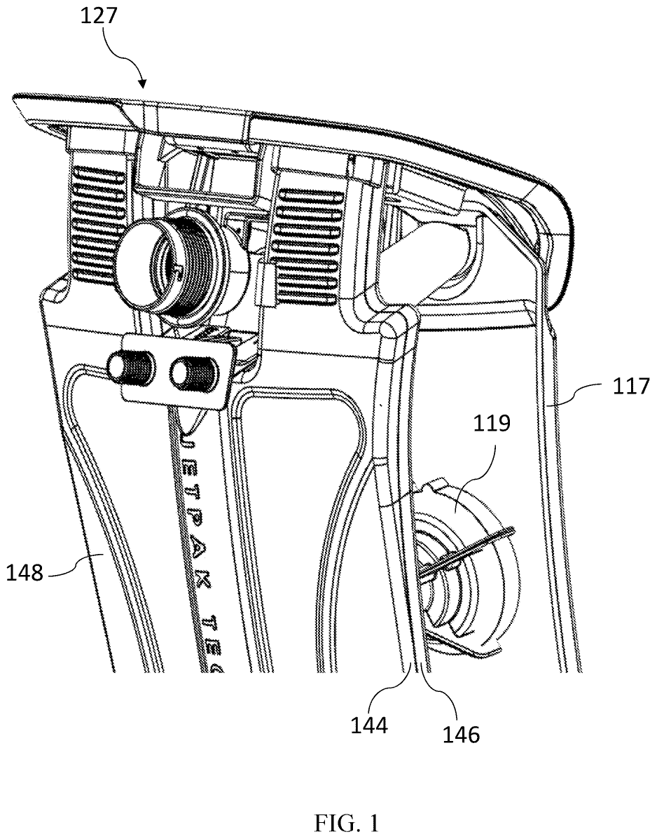

FIG. 1 illustrates a back, perspective view of an interchangeable jet module 127 (also referred to herein as “a jet module” or “the jet modules”) having a manifold and a jet plate 117. The jet modules 127, each with mounted jets 119, direct water and air into a containment, such as a spa in which the jet modules 127 are installed. Each jet module 127 includes jet plates 117, which provide stability for the jets 119 and which also provides a resting surface that may be generally continuous or flush with the surface of the containment.

The jet modules 127 fit within the hollows or impressions corresponding to seating areas of the containment or spa. A spa may have multiple occurrences of hollows and one or more different types of hollow locations. For example, configurations may include hollow locations at the corners and sides of a spa. Hollow locations may also be at a typical back region of a user, feet region, leg region, or another targeted body region. Also, hollows can be designed to contain one or more modules of suitable configuration. The modules designed to fit a single hollow design can differ from each other not only in jet configuration, but also, for example, in external contour (e.g. head rest) and texture. Instead of a separate air and water port, it is also contemplated that the hollow and its corresponding module be equipped with a single combination air and water connector and combination air and water port. Thus, water and air would be delivered as a unit to each jet module 127 within the spa.

As described in U.S. Pat. No. 9,662,268, already incorporated herein, many current systems have internal water distribution systems that result in uneven flows through the jets within the modules. Current systems allow water and air to exhibit vortex behavior within conduits of the modules, which yields uneven flow through the jets, ultimately causing discomfort to the user. For example, a vortex in the upper chamber or in one of the conduits may disrupt water flow in the upper chamber and prevent otherwise smooth, laminar flow to an upper jet, such that the flow to the upper jet is less than the flow going to the rest of the jets on the canister. To achieve a desired user comfort, these modules are limited to certain flow rates of air or water through the modules.

In contrast, the manifold 148 of the jet module 127 illustrated in FIG. 1 may include a generally thin member that comprises internal conduits or pathways that are also generally thin. Thus, less water may collect within the conduits or pathways. Such a configuration does not require as much material, is lightweight, and is not as bulky as previous jet canisters. Such a structure also prevents vortices and other disruptions on what would otherwise be a smooth or laminar flow. The manifold 148, and the module 127 as a whole, is thus lighter and easier to manipulate. While the jets 119 are sandwiched between the manifold 148 and jet plate 117, they remain exposed, and are not enclosed within a canister. Thus, the jets 119 may be routinely examined and also examined any time a jet problem occurs. Also, a jet 119 may be adjusted if needed.

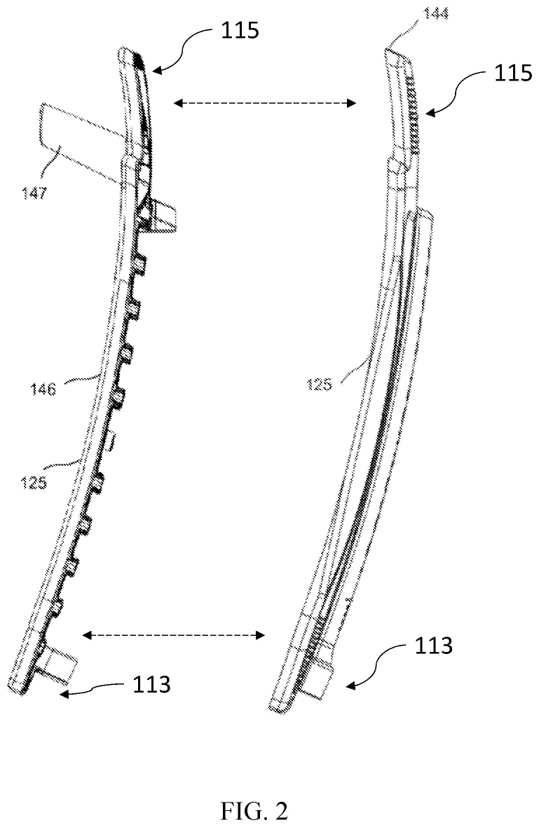

FIGS. 2 through 4 illustrate views of the manifold 148 from FIG. 1. As seen most clearly in FIG. 2, the manifold 148 may include a front or top portion 146 and a back or bottom portion 144. The top portion 146 is joined to the bottom portion 144 and a plurality of chambers (air and water) are defined and disposed therebetween. That is, each of the top portion 146 and the bottom portion 144 include interior structures (e.g., ridges or wall) including an array 154 of fluid (water and air) chambers, air baffles 150, venturi drain 152, air ports 139 and water connector 133. Air port(s) 139 may be provided at any suitable location. In some embodiments, one or more air port(s) 139 are provided near a top portion 115 of the jet module 127, which top portion 115 may be opposite a base portion 113 (FIG. 2). In other embodiments, air port(s) 139 are provided at different locations to optimize air flow within the jet module 127.

On the surface of the top portion 146 and facing away from the bottom portion 144, abutment members 147 extend radially outward from top portion 146. The number of abutment members 147 may be only one, or greater than two. The abutment members 147 are dimensioned to maintain the parallel distance between the manifold 148 and the jet plate 117. The abutment members 147, in addition to the jet, also help secure the plate 117 to the manifold 148. In the illustrated embodiment, the abutments 147 are placed near the top 115 of the jet module, where there may not be any jets, and additional support is required. If sufficient attachment between the jet plate 117 and the manifold 148 can be provided solely by the jets, the abutments 147 may be omitted.

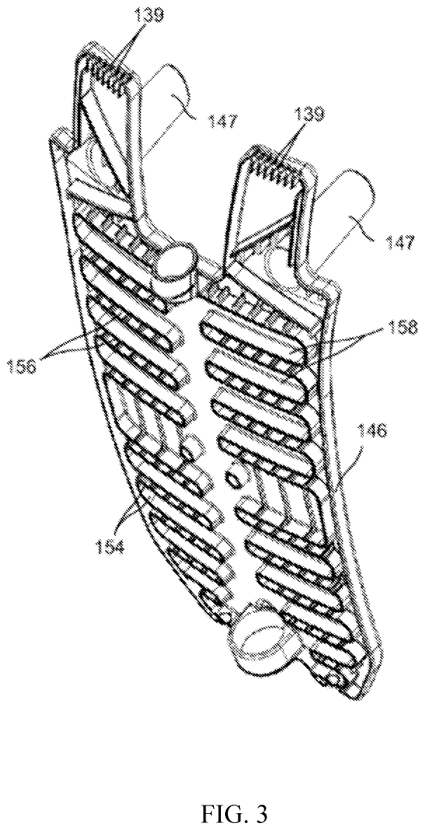

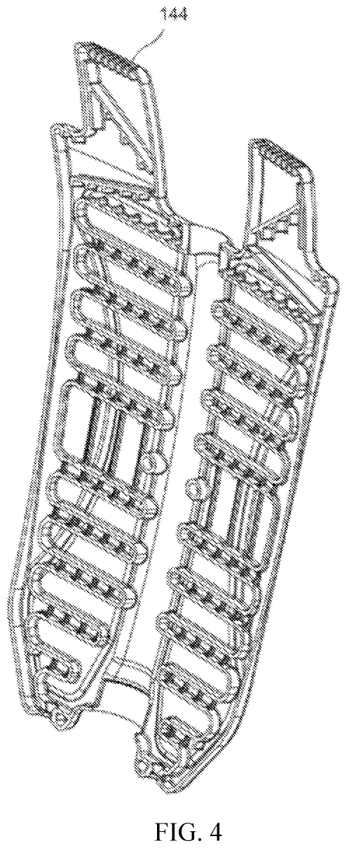

The top portion 146 of the manifold 148, which is connected or bonded to the bottom portion 144, has a matching structure and when bonded with the bottom section 144 forms the manifold 148 with an internal structure as shown in FIGS. 3 and 4. The top and bottom portions 146, 144 are similar, but may differ for external structures and be concave or convex curved, as shown in FIG. 2 so that when bonded form a curved manifold 148. The internal structures, and bonding surfaces of the top and bottom portion 144, 146 are mirrored in each other. Accordingly, when bonded, the internal structure of the manifold 148 (along the curved cross-sectional plane of the bonded surfaces) is represented by the figures.

For example, the array of water chambers and air chambers may be formed by a set of ridges or wall structures of the bottom portion 144 aligning and joining with the ridges or wall structures on a top portion 146. The joined ridges and walls may also form other structures, such as air baffles 150 and venturi drains 152. A function of the top portion 146 is to provide a jet mounting surface 125 with an underlying array of water and air chambers 156, 158. A function of the bottom portion 144 is to close the air and water chambers 156, 158 and provide independent fluid continuity, respectively for the air chamber and the water chamber. Accordingly, embodiments may include that the bottom portion 144 may not mirror, or only partially mirror the array in the top portion 146, providing alternate conduits, bypasses, three dimensional conduit configurations to provide fluid continuity in the air chamber and in the water chamber. Thus, embodiments may include that only the bottom portion 144 or only the top portion 146 have ridges or wall structures. In such embodiments, the section without ridges or wall structures serves to close off the ends of the ridges or wall structures to form the chambers.

The side-by-side array 154 of chambers comprise chambers 156, 158, which function as separate fluid supplies for two fluids, air and water respectively. The chambers comprise finger-like air chambers 156 that extend from the sides of the manifold 148 toward the central region of the manifold 148. Interspersed between the air chambers 156 are water chambers 158 that extend from the central region of the manifold 148 toward the sides of the manifold. Water flows through the water connector, into the central region and into the water chambers 158. Air, on the other hand, flows through the air port 139, through the air baffles 150, then along the sides and into the air chambers 156. In this manner, air and water spread throughout the manifold 148.

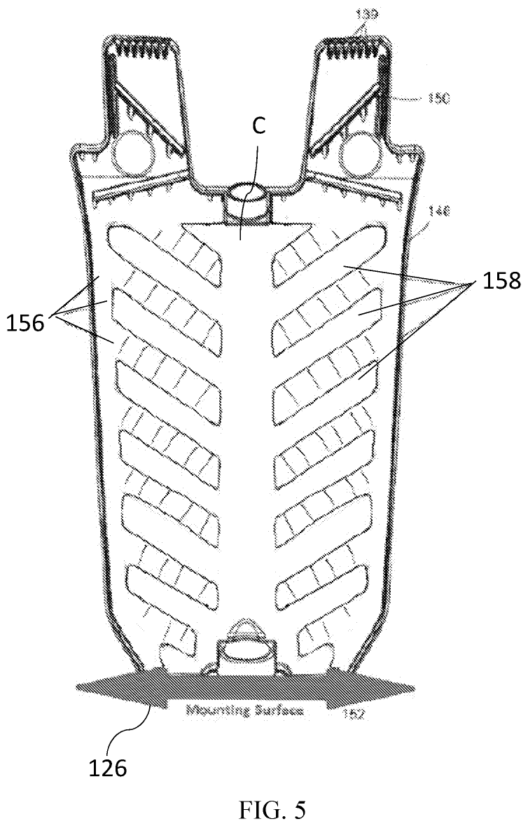

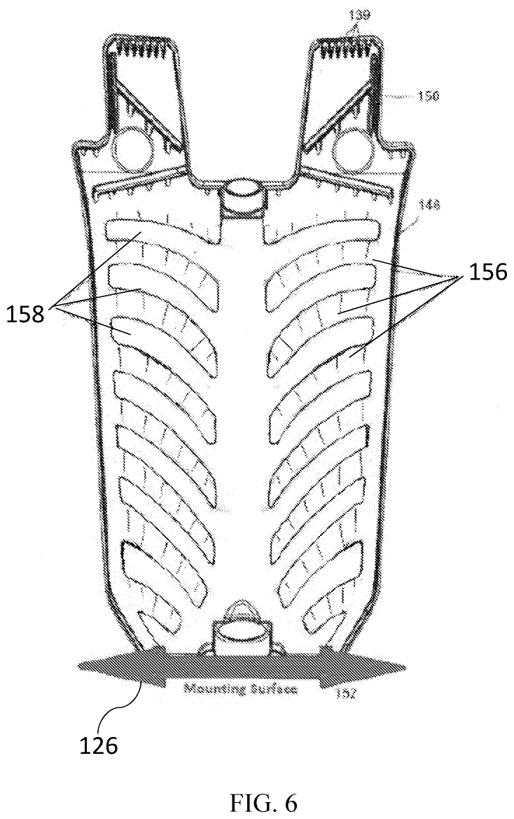

FIGS. 5 through 8 illustrate additional embodiments of the chambers 156, 158 of the manifold 148. As shown in FIGS. 5 and 6, each of the air and water chambers 156, 158 may be disposed at an angle relative to a manifold mounting surface 126. The angle may range from about 30° to about 50° relative to the manifold mounting surface 126. For example, the angle may be about 35°, 40°, 45°, or 47°. The chambers 156, 158 may be disposed symmetrically about a center line C of the manifold. The chambers 156, 158 may be mirror images of each other, such that a first array of chambers may be disposed at a first angle (e.g., 45°) and a second array of chambers may be disposed at a second angle that mirrors the first angle (e.g., −45°). In some embodiments, the chambers 156, 158 may form a chevron design.

The angle may reduce the amount of turbulence of water flowing through the water chambers 158 by reducing the angle of bend that the water flow has to go through. This reduces turbulence and drag through the chambers 158, which will increase flow and performance. Another benefit is that this helps with the drainage of the jet modules 127 when pulled out of the spa, as water more easily spills out of the angled chambers and down through the bulkhead port. The shape of the water chambers 158 may be concentric or non-concentric and may originate at a central point, such as the mounting surface 126.

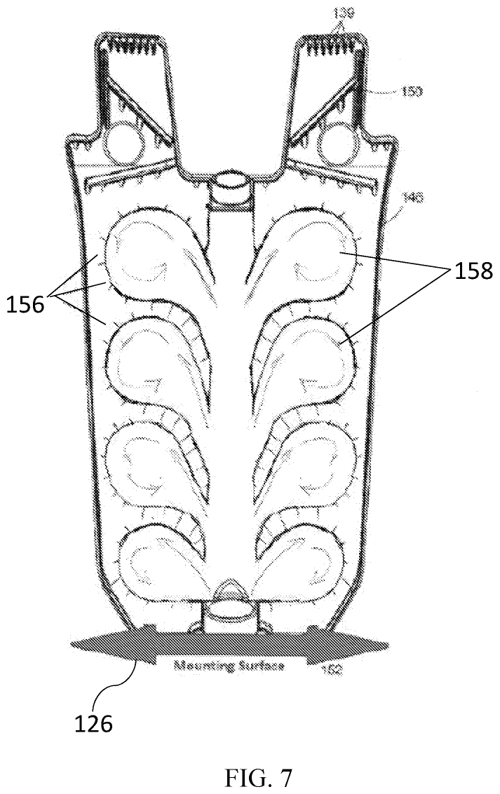

As seen in FIG. 7, the water chambers 158 may include larger, circular shaped chambers. The embodiment of FIG. 7 still allows air flow through the sides or outer edges of the manifold 148, as the air chambers 156 are now smaller and disposed more at the edges of the circular water chambers 158. This still allows for better drainage of the jet modules 127 and introduces a flow dynamic that does not allow the water to hit a dead end but rather continuously spiral in each of the water chambers 158. This continuous spiral may increase flow, and/or improve efficiencies.

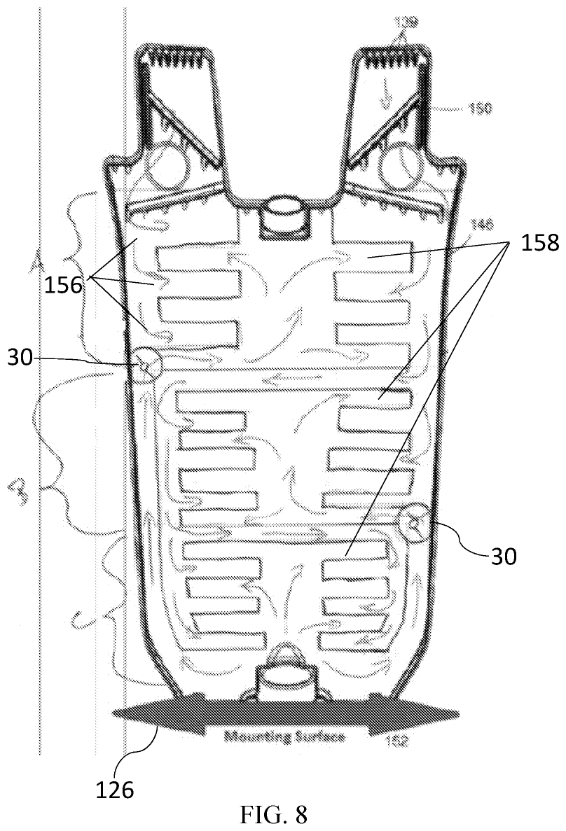

FIG. 8 illustrates another embodiment with independently controllable zones within the jet module 127. As seen in FIG. 8, the air and water chambers 156, 158 may be broken up into multiple, independently controllable zones (e.g., zone A, zone B, zone C). This may allow a user to shut of flow (air and water) within a zone to increase flow through another zone. By shutting down 1-2 zones of flow, it will increase the intensity of the other zones left open. The zones may be arranged vertically, as illustrated, or may be arranged in another appropriate fashion. Valves 30 may be disposed between adjacent zones and may be for controlling a flow of fluid through the zones. Additionally, the air and water chambers 156, 158 may be arranged as shown in FIG. 8, or may be arranged in any other suitable manner (such as the shapes shown in FIGS. 5-7).

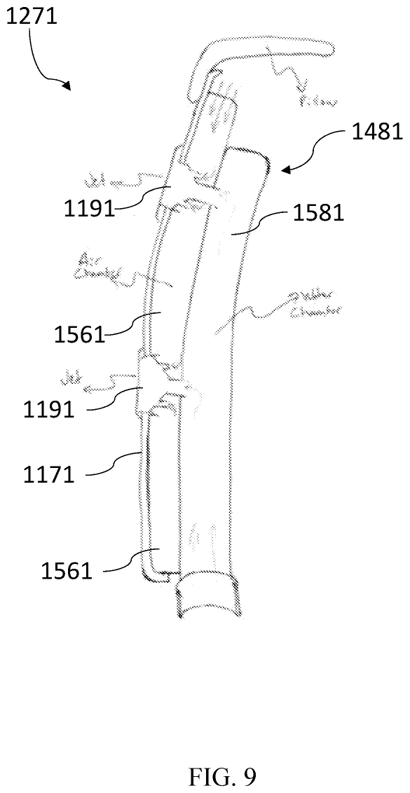

FIG. 9 illustrates a side view of another embodiment of an interchangeable jet module 1271 having a manifold 1481 and a jet plate 1171, with jets 1191 positioned between the manifold 1481 and the jet plate 1171. As illustrated, the manifold 1481 includes air chambers 1561 and a water chamber 1581, where the jets 1191 are positioned with the manifold 1481 such that the jets 1191 are in fluid communication with both the air chambers 1561 and the water chamber 1581. Instead of arranged angularly side-to-side, the chambers 1561, 1581 are arranged front-to-back. This design allows the jets 1191 to be placed in any location along the jet plate 1171 and the manifold 1481, as the jets 1191 will have access to the air chambers 1561 and the water chamber 1481 at any location. Modules 1271 with this arrangement may also include multiple venturi ports for air and significantly increase the effectiveness of air draw. This arrangement can also be compact, since much of the bodies of the jets 1191 can be embedded into the air chamber 1561 rather than between the chambers and jetplate.

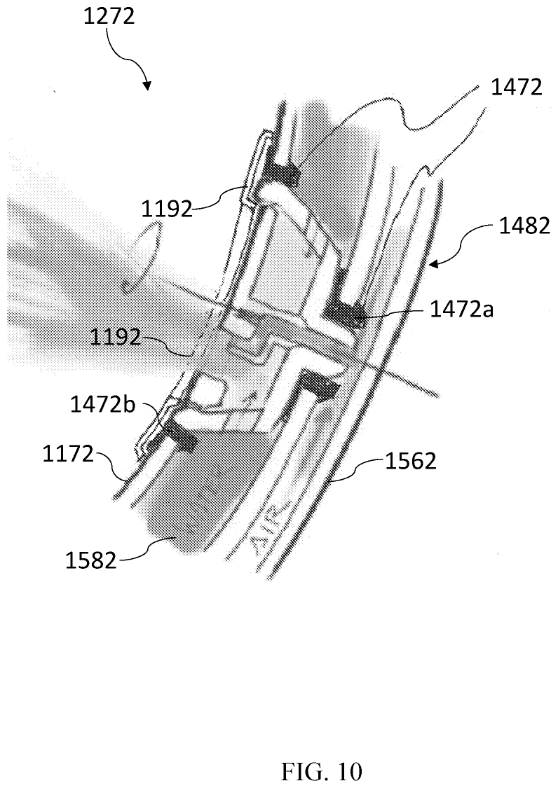

FIG. 10 illustrates a side view of another embodiment of an interchangeable jet 1272 module having a manifold 1482, a jet plate 1172, and a grommet or seal therebetween 1472. Similar to the module 1271 of FIG. 9, the module jet 1272 of FIG. 10 arranges the air and water chambers 1562, 1582 front to back. Also as before, the jets 1192 are positioned between the jet plate 1172 and the manifold 1482, such that the jets 1192 have fluid access to both the air and water chambers 1562, 1582. Air and water may be mixed within a body of the jet 1192, itself, rather than being mixed prior to delivery to the jet 1192. For example, the jet 1192 may have a portion that is in connection with the air chamber 1562 and a portion that is in connection with the water chamber 1582. As water and air flow from the respective chambers 1562, 1582 through the jet 1192, the air and water will be mixed together inside the jet 1992 before being expelled into the containment or spa. It will be appreciated that the positions of the air and water chambers may be reversed.

Positioned between the jets 1192 and both the jet plate 1172 and the air and water chambers 1562, 1582 is a dual layer grommet or seal 1472. The dual layer grommet 1472 includes a larger portion and a smaller portion. The larger portion may be positioned between the jet 1192 and the jet plate 1172. The smaller portion may be positioned between the jet 1192 and the air chamber 1562. Alternatively, the smaller portion may be positioned between the jet 1192 and the water chamber 1582, depending on the front-to-back order of the air and water chambers 1562, 1582. The jet 1192 is pressed into and extends through both portions of the grommet 1472, creating a seal in both layers (the jet plate 1172 and the manifold 1482). In some embodiments, the dual layer grommet 1472 may include two grommets, a larger grommet 1472b and a smaller grommet 1472a. The larger grommet 1472b may be positioned between the jet 1192 and the jet plate 1172. The smaller grommet 1472a may be positioned between the jet 1192 and the air chamber 1562.

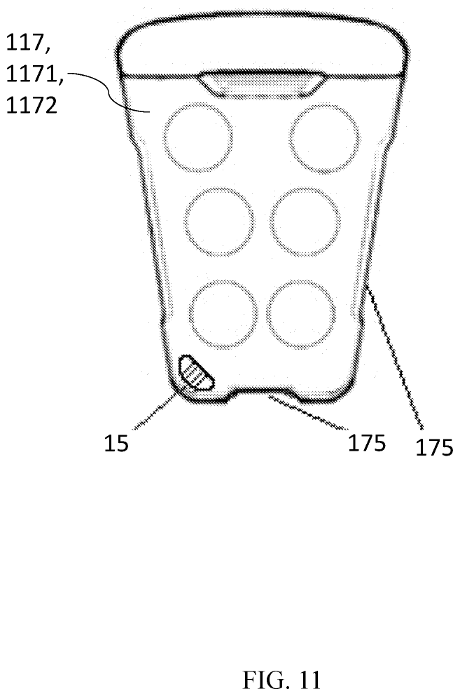

FIG. 11 illustrates a jet plate 117, 1171, 1172 of any one of the interchangeable jet modules 127, 1271, 1272 of FIG. 1, 9, or 10. As illustrated, the jet plate 117, 1171, 1172 includes a water flow channel 15 located near a bottom of the jet plate 117, 1171, 1172. The water flow channel 15 allows water to flow from a containment (such as a spa or hot tub) through the jet module, from a front side of a jet module to behind the jet module.

The jet plate 117, 1171, 1172 also includes water recessing features 175. Both the water flow insert 15 and the water recessing features 175 improve the flow of water to the suction within the jet module 127, 1271, 1272. This ensures that water will continuously flow through the chambers (e.g., air and water chambers 156, 158, 1561, 1581, 1562, 1582) of the jet module 127, 1271, 1272, preventing and/or reducing cavitation and drawing air into the pump.

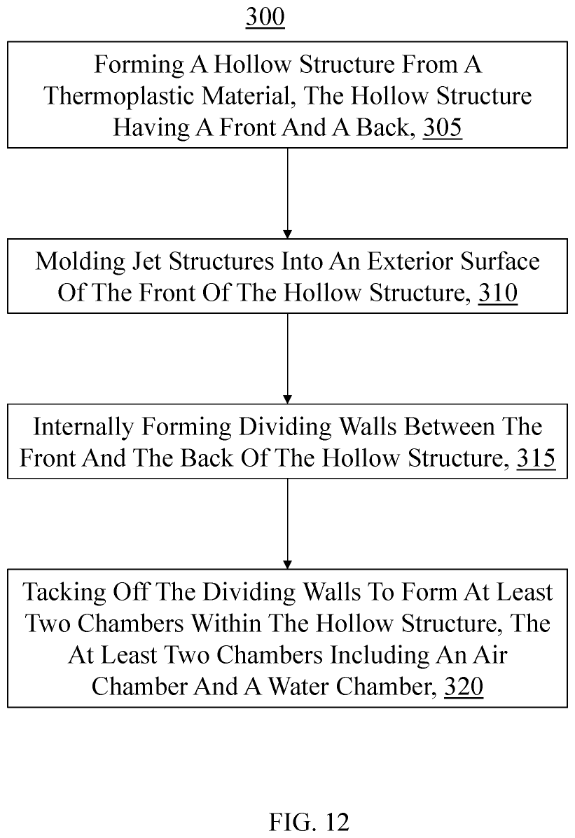

The interchangeable jet modules described herein can also be manufactured according to various methods. For example, the jet modules 127 may be partially or entirely blow-molded. FIG. 12 is a flowchart of one example method of manufacturing any one of the interchangeable jet modules of 127, 1271, 1272 FIG. 1, 9, or 10. The method 300 may include forming a hollow structure from a thermoplastic material, the hollow structure having a front and a back, at 305. The method 300 may also include molding jet structures into an exterior surface of the front of the hollow structure, at 310, and internally forming dividing walls between the front and the back of the hollow structure, at 315. The method 300 may further include tacking off the dividing walls to form at least two chambers within the hollow structure, the at least two chambers including an air chamber and a water chamber, at 320.

The molded jet structures may be in fluid communication with the at least two chamber, such that a mixture of air and water flows through the molded jet structures. Additionally, the molded jet structures may be for delivering the mixture of air and water into a containment, such as a spa. Forming the hollow structure may include blow-molding the thermoplastic material to form the hollow structure.

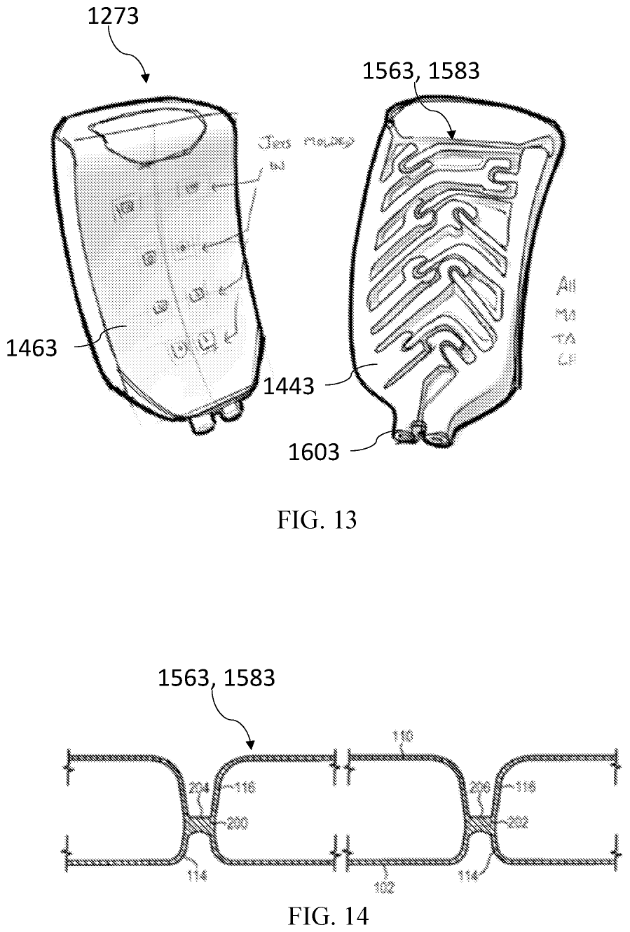

FIG. 13 illustrates one embodiment of an interchangeable jet module 1273 manufactured according to the method of FIG. 12. As seen, the jet module 1273 has no seams or joints that may lead to failure or breakage of the jet module 1273. Also shown are a plurality of chambers 1563, 1583 that may be formed through dividing walls or by kissing portions of the front 1463 to the back 1443. A drain, bulkhead fitting, or port 1603 may also be formed at the bottom of the module 1273.

FIG. 14 illustrates a cross-sectional view of the chambers 1563, 1583 formed in the manifold from the interchangeable jet module 1273 of FIG. 13. Specifically, illustrated is the tacking or kissing off of dividing walls 110, 102 to form individual chambers. Junctions 204, 206 may be formed between adjacent chambers.

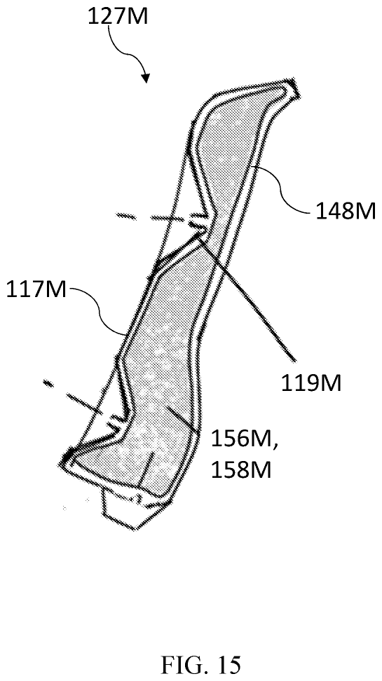

FIG. 15 illustrates a side cross-sectional view of an interchangeable jet module 127M formed from the process described in FIG. 12. As illustrated, the jet 119M is molded into the jet plate 117M. In some embodiments, the entirety of the jet 119M (a jet body for receiving air and water, a nozzle, etc.) may be molded into the jet plate 117M. Alternatively, a cavity or depression may be molded into the jet palte 117M, and a jet body can be inserted or screwed into the cavity or depression. Also illustrated is a portion of the manifold 148M, having a volume of premixed air and water contained within one of the air or water chambers 156M, 158M of the manifold 148M. The air and water may be mixed directly behind the jet plate 117M to be delivered to the jet 119M.

### Additional Terms and Definitions

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It should also be noted that some of the embodiments disclosed herein may have been disclosed in relation to a particular water-containing vessel (e.g., a spa); however, other vessels (e.g., pools, tubs, swim spas, etc.) are also contemplated. A spa is also known in the industry as a hot tub and is generally formed of a concave shell to receive and contain water. Structures, such as a jet, can extend through the concave shell to move water from a surface outside the spa to a surface inside the spa or shell. Surfaces inside the shell are referred to as more “proximal” while surfaces that extend through the shell are referred to as “distal.” A proximal side of a jet faces the spa shell where the user relaxes, and the jet can provide hydrotherapy to the user in the spa.

In one embodiment, the terms “about” and “approximately” refer to numerical parameters within 10% of the indicated range. The terms “a,” “an,” “the,” and similar referents used in the context of describing the embodiments of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the embodiments of the present disclosure and does not pose a limitation on the scope of the present disclosure. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments are described herein, including the best mode known to the author(s) of this disclosure for carrying out the embodiments disclosed herein. Of course, variations on these described embodiments will become apparent to those of ordinary skill in the art upon reading the foregoing description. The author(s) expects skilled artisans to employ such variations as appropriate, and the author(s) intends for the embodiments of the present disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of this disclosure so claimed are inherently or expressly described and enabled herein.

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

What is claimed:

1. An interchangeable jet module comprising:
at least one jet;
a manifold with a mounting surface for mounting a base portion of the at least one jet;
a jet plate with a mounting surface for mounting a top portion of the at least one jet;
an array of air and water chambers underlying the manifold mounting surface,
wherein the air chambers are configured to receive air from an air supply and communicate the air to the at least one jet, wherein the water chambers are configured to receive water from a water supply and communicate the water to the at least one jet, and wherein the at least one jet communicates air and water to an external environment,
the array of air and water chambers being arrayed side-by-side to each other in a cross-sectional plane generally parallel to and underlying the manifold mounting surface, the array configured to allow multiple mounting locations on the manifold mounting surface wherever the underlying side-by-side water and air chambers are capable of being accessed by spaced air and water intakes on the at least one jet,
each air and water chamber of the array being set at an angle relative to the manifold mounting surface, the angle configured to (i) reduce turbulence of water flowing through the water chambers, (ii) reduce drag of air flowing through the air chambers, and (iii) increase drainage of water from the manifold.

2. The interchangeable jet module of claim 1, wherein the angle ranges from about 30° to about 50° relative to the manifold mounting surface.

3. The interchangeable jet module of claim 2, wherein the angle is about 45°.

4. The interchangeable jet module of claim 1, wherein the array or air and water chambers comprises a first array of air and water chambers are disposed at a first angle relative to the manifold mounting surface and a second array of air and water cambers are disposed at a second angle relative to the manifold mounting surface, the second array of air and water chambers being a mirror image of the first array of air and water chambers about a center line of the manifold.

5. The interchangeable jet module of claim 1, wherein the array of air and water chambers comprise substantially linear chambers.

6. The interchangeable jet module of claim 1, wherein the array of air and water chambers comprise circular water chambers.

7. The interchangeable jet module of claim 1, wherein the array or air and water chambers comprise curved chambers.

8. An interchangeable jet module comprising:
at least one jet;
a manifold with a mounting surface for mounting a base portion of the at least one jet;
a jet plate with a mounting surface for mounting a top portion of the at least one jet;
a first array of air and water chambers underlying the manifold mounting surface;
a second array of air and water chambers underlying the manifold mounting surface and in fluid communication with the first array of air and water chambers through a valve;
a third array of air and water chambers underlying the manifold mounting surface and in fluid communication with the first array of air and water chambers and the second array of air and water chambers through a second valve,
wherein the air chambers of each of the first, second, and third arrays are configured to receive air from an air supply and communicate the air to the at least one jet, wherein the water chambers of each of the first, second, and third arrays are configured to receive water from a water supply and communicate the water to the at least one jet, and wherein the at least one jet communicates air and water to an external environment,
the first, second, and third arrays of air and water chambers being arrayed vertically in a cross-sectional plane generally parallel to and underlying the manifold mounting surface, and
actuation of the valve cutting off fluid communication between the first array of air and water chambers and the second array of air and water chambers.

9. A method of manufacturing an interchangeable jet module, the method comprising:
forming a hollow structure from a thermoplastic material, the hollow structure having a front and a back;
molding jet structures into an exterior surface of the front of the hollow structure;
internally forming a dividing wall between the front and the back of the hollow structure; and
tacking off the dividing wall to form at least two chambers within the hollow structure, the at least two chambers including an air chamber and a water chamber,
the molded jet structures being in fluid communication with the at least two chamber, such that a mixture of air and water flows through the molded jet structures, and
the molded jet structures for delivering the mixture of air and water into a containment, such as a spa.
